(19) United States
(12) Patent Application Publication
(10) Pub. No.: US 2026/0356753 A1
(43) Pub. Date: Nov. 12, 2026

(54) CEMENTITIOUS COMPOSITIONS COMPRISING FIBER-SUPPORTED POZZOLANIC MATERIALS

(71) Applicant: William B. Coe, Wrightwood, CA (US)

(72) Inventor: William B. Coe, Wrightwood, CA (US)

(21) Appl. No.: 19/133,197

(22) PCT Filed: Nov. 27, 2023
(86) PCT No.: PCT/US2023/081178

§ 371 Date: May 27, 2025

Related U.S. Application Data
(60) Provisional application No. 63/385,160, filed on Nov. 28, 2022.
(60) Provisional application No. 63/480,435, filed on Jan. 18, 2023.

(51) Int. Cl. C04B 20/00; C04B 7/02; C04B 16/02; C04B 20/10; C04B 20/12; C04B 28/04

(52) U.S. Cl. CPC C04B 20/0068; C04B 7/02; C04B 16/02; C04B 20/1037; C04B 20/1066; C04B 20/1077; C04B 20/12; C04B 28/04

(57) ABSTRACT

Methods and compositions related to cement, e.g., portland cement, or portland-limestone cement (PLC), including fiber-supported pozzolanic materials are provided. The methods offer greater cost and/or energy efficiency in producing the cement, with improvements to the properties of the resulting cements.

### INCORPORATION BY REFERENCE TO RELATED APPLICATIONS

Any and all priority claims identified in the Application Data Sheet, or any correction thereto, are hereby incorporated by reference under 37 CFR 1.57. This application is the U.S. National Phase of International Application No. PCT/US2023/081178 filed Nov. 27, 2023, which claims the benefit of U.S. Provisional Application No. 63/385,160, filed Nov. 28, 2022 and U.S. Provisional Application No. 63/480,435 filed Jan. 18, 2023. Each of the aforementioned applications is incorporated by reference herein in its entirety, and each is hereby expressly made a part of this specification.

### FIELD OF THE INVENTION

Methods and compositions related to cement, e.g., portland cement, or portland-limestone cement (PLC), including fiber-supported pozzolanic materials are provided. The methods offer greater cost and/or energy efficiency in producing the cement, with improvements to the properties of the resulting cements.

### BACKGROUND OF THE INVENTION

According to World Bank data from 2016, the world generated 242 million tons of plastic waste-12 percent of all municipal solid waste. This waste primarily originated from three regions-57 million tons from East Asia and the Pacific, 45 million tons from Europe and Central Asia, and 35 million tons from North America.

Plastic waste mainly enters the environment when it is poorly managed, such as through open dumping, open burning, and disposal in waterways. Unfortunately, with more than one-fourth of waste dumped openly and many formal disposal sites managed improperly, plastic litter is increasing. Even when plastic waste is collected, many countries lack capacity to process the waste. In 2017, Europe exported one-sixth of its plastic waste, largely to Asia (The Economist 2018).

Globally approximately fourteen percent (14%) of plastic waste is recycled. The rest ends up as unrecoverable trash, in landfills or as transient litter. China, India and many other Asia Pacific countries have placed bans on import of plastic waste for recycling. These bans are accentuating the global plastic crisis. Many cities in advanced economies, faced with mountains of plastic waste, are struggling to expand landfill capacities. The United States now must recycle more of its waste at home, an imperative that has prompted American firms and regional governmental agencies to pour investments into plastic recycling plants. With virgin plastic becoming more cost effective than recycled plastic, agencies are beginning to offer manufacturers tax concessions to switch to recycled plastic.

Against this background, nearly 180 countries agreed to a new U.N. accord to regulate the export of plastic waste, some eight million tons of which ends up in the oceans each year—the equivalent of one garbage truck of plastic being dumped into the world's oceans every sixty seconds. The accord amends the 1989 Basel Convention on the control of hazardous wastes to include plastic trash.

While concrete is a sustainable building material—providing energy efficiency, long-life cycle, lower life-cycle costs and resilience—its manufacture generates considerable emissions. Currently, based on U.S. Environmental Protection Agency (EPA) carbon emissions data, the manufacture of cement accounts for 1.25% of U.S. CO₂ emissions—with demand projected to increase. Cement is the source of about 8% of the world's carbon dioxide emissions, according to think tank Chatham House. If the cement industry were a country, it would be the third largest emitter in the world—behind China and the US. It contributes more CO₂ than aviation fuel (2.5%) and is not far behind the global agriculture business (12%).

### SUMMARY OF THE INVENTION

While extensive research efforts over many years have been devoted to development of methods for recycling plastic waste streams, such methods have heretofore been of limited use. There are seven categories of plastics, denoted by their recycling symbols, that are commonly encountered in recycling. The most commonly recycled plastics include polyethylene terephthalate (PET-1), used to make water bottles, and high-density polyethylene (HDPE-2). Other types of plastics that are commonly recycled include low density polyethylene (LDPE-4) polypropylene (PP-5), polystyrene (PS-6) and polyvinyl chloride (PVC-3). However, there are certain polymers (e.g., acrylic, nylon, mixed polymeric materials, etc.) that are difficult to recycle (Other-7). Such recycled plastic is often downcycled into a different, less useful product which may be unfit for another round of recycling. Conventional recycling of plastics also involves complex sorting, pretreatment, extrusion, pelleting and manufacture processes, such as injection molding. The present methods provide an improvement to conventional processes in that they are able to provide a fibrous recycled material suitable for use in cement manufacture, with significant advantages as to sustainability, cost effectiveness, and/or significant property improvement of the resulting cement.

Extensive research efforts over many years have been devoted to development of compositions and methods for providing portland cement of superior properties, e.g., fineness, soundness, setting time, and/or strength. The present methods provide an improvement to these compositions and methods, enabling the preparation of portland cement having one or more superior properties when compared to conventional portland cements. The compositions and methods can also offer advantages in terms of sustainability, recycled material content, cost effectiveness, and/or other advantages.

Accordingly, one of the objects of certain disclosed methods and compositions that reduce the environmental impact of cement lifecycle, including manufacturing, are provided. Another of the objects of certain disclosed methods and compositions is to provide a satisfactory cement at a reduced materials and/or energy cost. Another of the objects of certain disclosed methods and compositions is to provide cement compositions exhibiting one or more superior properties when compared to conventional cement compositions.

Accordingly, in a generally applicable first aspect (i.e., independently combinable with any of the aspects or embodiments identified herein), a pozzolanic fiber is provided, comprising a polymeric fiber having a coating comprising a precipitated silica and a maleic anhydride-dicyclopentadiene resin interlocked with a montmorillonite.

In an embodiment of the first aspect (i.e., independently combinable with any of the aspects or embodiments identified herein), the polymeric fiber comprises one or more polymers selected from the group consisting of polyethylene terephthalate, high density polyethylene, polyvinyl chloride, low density polyethylene, polypropylene, and polystyrene.

In an embodiment of the first aspect (i.e., independently combinable with any of the aspects or embodiments identified herein), the one or more polymers is derived from a recycled material.

In an embodiment of the first aspect (i.e., independently combinable with any of the aspects or embodiments identified herein), the one or more polymers is virgin polymer.

In an embodiment of the first aspect (i.e., independently combinable with any of the aspects or embodiments identified herein), the polymeric fiber has a diameter of 0.5 to 2 mm, optionally 1.0 to 1.5 mm, optionally 1.2 mm.

In an embodiment of the first aspect (i.e., independently combinable with any of the aspects or embodiments identified herein), the polymeric fiber has an aspect ratio of from 5:1 to 100:1, optionally 10:1 to 50:1, optionally 10:1, optionally 20:1, optionally 30:1, optionally 40:1, optionally 50:1, optionally 60:1, optionally 70:1, optionally 80:1, optionally 90:1, or optionally 100:1.

In an embodiment of the first aspect (i.e., independently combinable with any of the aspects or embodiments identified herein), the precipitated silica has a cured coating thickness of 7-10 nm and is reaction coated with an approximately 10-30 nanometers, optionally 20 nanometer thick surfacing of maleic anhydride-dicyclopentadiene resin.

In an embodiment of the first aspect (i.e., independently combinable with any of the aspects or embodiments identified herein), the precipitated silica of the coating comprises a plurality of shafts, each with an individual shaft diameter of approximately 150-300 nm with an aspect ratio of approximately 10-30:1, optionally 20:1.

In an embodiment of the first aspect (i.e., independently combinable with any of the aspects or embodiments identified herein), the montmorillonite is a nano-montmorillonite.

In an embodiment of the first aspect (i.e., independently combinable with any of the aspects or embodiments identified herein), the montmorillonite is a Na-montmorillonite, a Li-montmorillonite, or a Ca-montmorillonite.

In an embodiment of the first aspect (i.e., independently combinable with any of the aspects or embodiments identified herein), the montmorillonite is a bentonite.

In an embodiment of the first aspect (i.e., independently combinable with any of the aspects or embodiments identified herein), the coating further comprises an amino-silane, optionally 3-trimethoxysilylpropylamine.

In in a generally applicable second aspect (i.e., independently combinable with any of the aspects or embodiments identified herein), a cementitious material is provided, optionally a portland cement, comprising a pozzolanic fiber of the first aspect or any embodiment thereof, wherein the pozzolanic fiber is optionally present at 1-10 wt. %, optionally 5 wt. %.

In in a generally applicable third aspect (i.e., independently combinable with any of the aspects or embodiments identified herein), a concrete is provided, comprising a cementitious material, optionally portland cement, and a pozzolanic fiber of the first aspect or any embodiment thereof.

In in a generally applicable fourth aspect (i.e., independently combinable with any of the aspects or embodiments identified herein), a method of preparing a pozzolanic fiber is provided, comprising: coating a polymeric fiber with a solution of a precipitated silica and a maleic anhydride-dicyclopentadiene resin and flash curing to remove any volatiles, whereby a cured coating is obtained; and depositing a solution of montmorillonite onto the cured coating and flash curing to remove any volatiles, whereby a pozzolanic fiber is obtained.

In in a generally applicable fifth aspect (i.e., independently combinable with any of the aspects or embodiments identified herein), a cellulose nanofiber is provided, wherein the cellulose nanofiber is treated with polyvinyl alcohol followed by silicic acid, optionally with tetramethylpiperidinyl-oxyl.

In in a generally applicable sixth aspect (i.e., independently combinable with any of the aspects or embodiments identified herein), a rubber material is provided comprising a ground tire rubber and a ferro-cellularized soybean oil.

In an embodiment of the sixth aspect (i.e., independently combinable with any of the aspects or embodiments identified herein), a ratio of ferro-cellularized soybean oil to ground tire rubber is 5:95 by weight.

In in a generally applicable seventh aspect (i.e., independently combinable with any of the aspects or embodiments identified herein), a cementitious material is provided comprising a cement, optionally portland cement, and a ferro-cellularized soybean oil, wherein the ferro-cellularized soybean oil is optionally present in the cementitious material at 2 wt. %.

In an embodiment of the seventh aspect (i.e., independently combinable with any of the aspects or embodiments identified herein), the cementitious material further comprises cellulose nanofibers, wherein the cellulose nanofibers comprise from 2 to 10% by weight of the cementitious material.

### DESCRIPTION OF THE DRAWINGS

FIG. 1 depicts nano-montmorillonite-high intercalation potential.

FIG. 2A depicts the DCPD MAH reaction process.

FIG. 2B depicts a schematic interaction with SiO₂ groups for precipitated silica-A and montmorillonite-B.

FIG. 3 illustrates a process for preparing P47 fiber.

FIG. 4 provides a comparison of chemical compositions, physical properties and mechanical properties of a conventional cement and a cement reinforced with P47 fiber.

### DETAILED DESCRIPTION OF THE EMBODIMENTS

The following description and examples illustrate an embodiment of the present invention in detail. Those of skill in the art will recognize that there are numerous variations and modifications of this invention that are encompassed by its scope. Accordingly, the description of an embodiment should not be deemed to limit the scope of the present invention.

### Introduction

Portland cement (inclusive of its derivatives) is the most utilized construction material, and the second most consumed commodity in the world after water. Its demand has soared proportionately with the exponential rise in population and the need to match the required development. The energy-intensive processes that are involved in its production contribute to about 7 to 10 percent (%) of the total, annual global carbon emissions, with many adverse environmental implications. These processes, and generally those of the production of concrete (worldwide ca. 5B metric tons annually) consume heavily on natural resources such as sand, gravel, water, coal and crushed rock.

However, it is possible that energy and cost efficiency can be achieved by reducing on the amount of clinker, and in its place utilizing supplementary cementitious materials (SCMs) or pozzolans (a broad class of siliceous and aluminous materials which, in themselves, possess little or no cementitious value but which will, in finely divided form and in the presence of water, react chemically with calcium hydroxide (Ca(OH)₂) at ordinary temperature to form compounds possessing cementitious properties) that require less process heating and emit fewer levels of carbon dioxide (CO₂). Flexural and compression strength gains may also be achieved by using steel, glass or plastic fiber reinforcement(s) thereby reducing the total concrete thickness required to meet structural specifications.

Several types of chemical reactions take place in concrete containing pozzolans as a partial cement replacement. A pozzolanic material relies on the secondary reaction following the hydration of cement, whereby it reacts with the free calcium hydroxide to form the calcium silicate hydrates (C—S—H) phase which is the major contributor to strength in concrete; as a result there is long term strength development up to and beyond 91 days in pozzolanic concrete. Due to the depleted levels of calcium hydroxide, pozzolanic concrete impart superior water adsorption/absorption and sulfate resistance.

Concrete strength enhancement by fiber is limited by the load transfer along the fiber shaft as the three popular fiber materials have no chemical bond with the cement or, alternatively, by means of shaft roughness or putting a hook on each end of the fiber. The latter method being minimally used as it raises the difficulty of flow during concrete installation.

A four-step process method is provided for producing fibers for use in the disclosed concrete materials. These fibers are inclusive of any combination of the seven categories of scrap plastic, and/or in combination with virgin plastic, which yields a strong fibrous thread that has a thermo-hydraulically stable, covalent chemically bonded outer shell of a water-activated pozzolanic (P), nano-frit. When blended into portland cement, the outer shell of the fibrous thread hydrates and reacts chemically as noted above, becoming an integral component of the concrete substrate; thereby transferring the full strength along the fiber shaft to other elements of the concrete substrate. Fibrous materials derived by the four step process described herein and manufactured from any combination of the seven categories of scrap plastic are referred to herein as “P47 fiber”.

### Pozzolanic Fibers

Pozzolanic fibers of one embodiment comprise a plastic. While a process for preparing the fibers is described herein, other processes as are known in the art for preparing plastic fibers can also be employed to generate fibers that possess similar dimensions. The pozzolanic fibers of one embodiment can be prepared by the following process. A starting material chemically comprising one or more of the seven categories of recycled plastics (as either actual recycled materials, and/or as virgin materials) can advantageously be employed. These plastics include, but are not limited to, polyethylene terephthalate, high density polyethylene, polyvinyl chloride, low density polyethylene, polypropylene, and polystyrene. This starting material is batch-processed as a maw. The process involves four steps.

### Step One—Incoming Scrap Plastic Decontamination

1. Pre-sorting, continuous moving trays containing recyclable plastic articles by hand or computer. This step removes articles of rubber, wood, cardboard, metal and large chunks of building material such as insulation, sheet rock, etc.

2. The sorted articles are passed to a high pressure, agitated water scrubbing tank where smaller contaminates such as dirt, floating debris, labels, etc. are purged. This water is continuously recycled through a filtering system.

3. The washed recyclable articles are passed to a counter-rotating knife and grinding wheels (cold grinding) where all the mixed plastic and small amounts of labels and metal are reduced to a fine mesh (typically 150-200 microns in size, although smaller or larger particles may be present). Thereafter the damp, exiting powderized material passes over a metal separator to remove iron and/or aluminum based fragments.

4. The powderized material is processed in a water press and spin drying apparatus which removes 99.5% of all remaining moisture.

While these steps can be employed when raw recycled material (scrap plastic) is employed, sorting, cleaning, and or dewatering steps can be omitted if only virgin materials are employed, or one or more steps may be omitted depending on the state of the recycled material provided, e.g., if the recycled material is provided in a clean and dewatered powderized form the steps may be omitted.

### Step Two—Co-Rotating Twin Screw Extruder

1. Flow of mixed plastics is stuffed, heated, mixed, melted and moved to a final stage of processing as a melt which is extruded as a strand.

2. At the end of the extruder barrel are tapered screws that increase the pressure (e.g., 6,000-10,000 psi). Even at this high pressure, the heated plastic media will have remaining wood, metal and thermoplastic bits that exceed a maximum size of 150 microns. A rotating breaker plate at the end of the extruder barrel will capture these particles and remove them, as a continuous process. These oversized contaminates are cooled and re-circulated to STEP ONE (Item 3) size reduction equipment.

3. The material exiting the extruder as an approximately 25 mm diameter, round ribbon is spot tested for tensile strength.

### Step Three—Added Polymer Compounding and ‘Fuzzy’ Pre-Coating

1. Subject to sampling of the ribbon of STEP TWO, the material moves through a second extruder stage for final processing. Additional polymer(s) may be added to bring the material from STEP TWO plastic ribbon to a desired specification.

2. A multi-strand formation at the end of this STEP THREE extruder is continuously formed at a diameter of approximately 1.5 mm and then partially cooled in a water bath. Other diameters that are higher or lower may also be employed for certain embodiments.

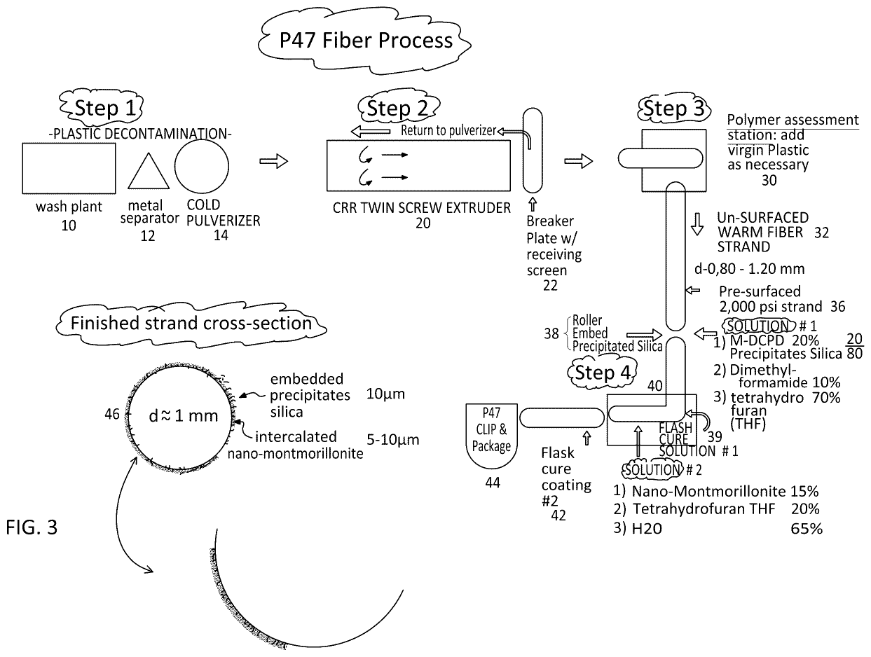

3. As these strands exit the bath, they enter a misting chamber where Solution #1 (Solution #1 as described in FIG. 3) is fogged onto the warm surface of the traveling strands at a thickness of approximately 10-20 microns. Solution #1 solvent softens the plastic material of the strands. Immediately thereafter, the strands enter a tapered aperture which squeezes the approximately 1.5 mm diameter down to a diameter of approximately 1.2 mm. In certain embodiments a higher or lower diameter may be employed (e.g., 0.5 to 2 mm, or 1.0 to 1.5 mm). The strands may possess a circular cross section, but other shapes can also be employed, e.g., rectangular, ribbon-like, polygon, oval, or the like. The squeezing embeds the components of the two surfaces (the surface of the coating and the surface of the fiber) together.

4. Upon exiting the size reduction aperture, the embedded coating of the traveling strands from Solution #1 is flashed cured to remove any volatiles, thereby achieving a cured coating with a nominal thickness of 7-10 microns (although higher or lower thicknesses may be employed in certain embodiments, e.g., 5 to 20 microns, or higher or lower). The coating is “fuzzy” as the precipitated silica component of Solution #1, now itself being reaction-coated with an approximately 20 nanometer thick surfacing of maleic anhydride-dicyclopentadiene resin (M-DCPD), has an individual shaft diameter of approximately 150-300 nm with an aspect ratio of approximately 20:1. In certain embodiments, other diameters and aspect ratios for the shafts of the “fuzzy” coating may be present. For example, the shaft diameter can be 50 nm to 500 nm, or higher, or lower, or any value or range of values in between. The aspect ratio can be from 10:1 to 100:1, or higher, or lower, e.g., 10:1, 20:1, 30:1, 40:1, 50:1, 60:1, 70:1, 80:1, 90:1, or 100:1, or any value or range in between. Some entangled aggregates of the precipitated silica particles appear as such on the surface of the individual strands.

### Step Four—Pozzolanic Shell Installation

1. The traveling strands enter a chamber where Solution #2 (as described in FIG. 3) is fogged onto and reacted and interlocked with the ‘fuzzy’ surface of the travelling strand(s) at a thickness of approximately 15-20 microns (or higher or lower, e.g., 10-30 microns or any range or value in between).

2. As the traveling strands exit the fogging chamber, they are flash cured of volatiles, which results in the formation of an outer reactive shell with a nominal thickness of approximately 10 microns.

3. The traveling strands are then clipped to lengths of 10-25 mm and packaged. The aspect ratio of the clipped strands can be from 5:1 to 100:1, or 10:1 to 50:1, or higher, or lower, e.g., 10:1, 20:1, 30:1, 40:1, 50:1, 60:1, 70:1, 80:1, 90:1, or 100:1, or any value or range in between.

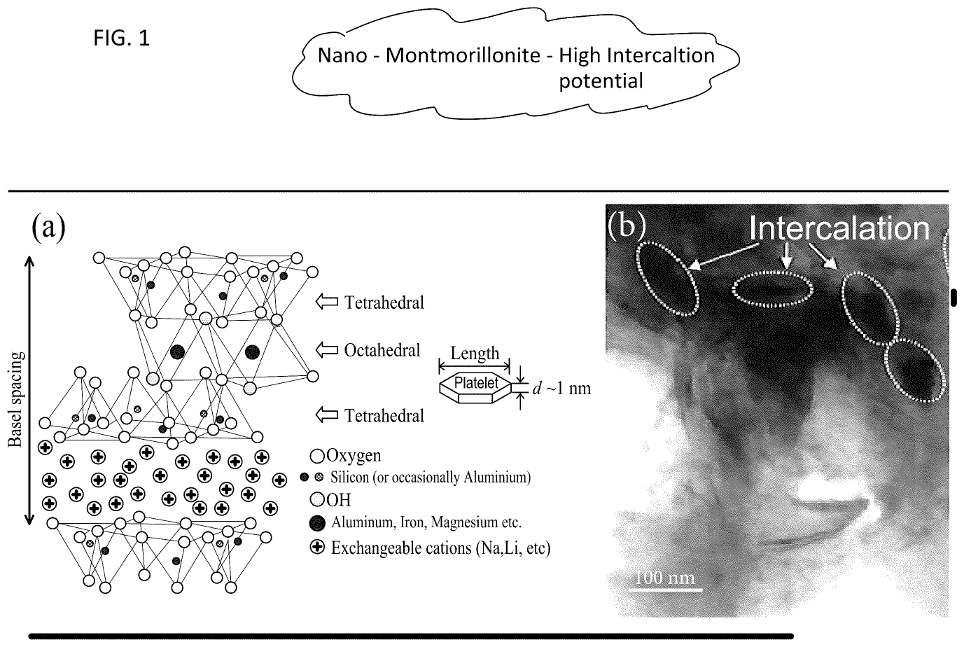

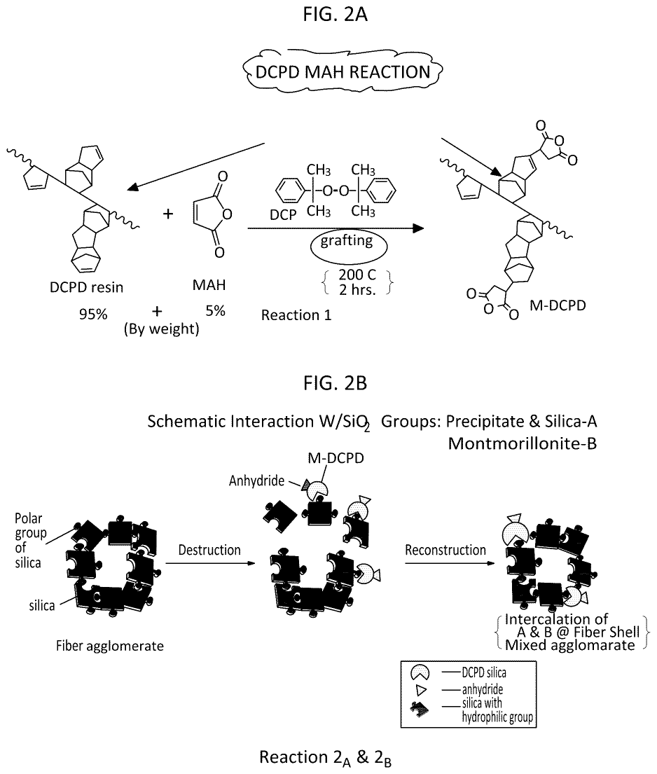

As noted above, an exemplary pozzolanic material is nano-montmorillonite, which has a high intercalation potential (see FIG. 1). Bentonite, a suitable pozzolanic material for use in the embodiments, is an absorbent swelling clay consisting mostly of montmorillonite (a type of smectite) which can either be Na-montmorillonite or Ca-montmorillonite. Montmorillonites can have various exchangeable cations (e.g., sodium, lithium, calcium, or other alkaline earth or alkali metals). Intercalated materials may include aluminum, iron, magnesium, or other metals. FIG. 2A depicts the reaction of dicyclopentadiene (DCPD and maleic anhydride (MAH) to yield M-DCPD. Typically, a mixture of 95 wt. % DCPD resin is combined with 5 wt. % MAH, and subjected to a grafting reaction in the presence of dicumyl peroxide (DCP) at a temperature of 200 °C for 2 hours. FIG. 2B depicts how the silica groups of the pozzolanic material interact with M-DCPD anhydride. The silica forms a fiber agglomerate which undergoes destruction and reconstruction into an intercalated mixed agglomerate in the pozzolanic shell of the fiber.

FIG. 3 depicts a schematic of the overall process and description of Solution #1 and Solution #2. In Step 1, a series of a wash plant 10, a metal separator 12, and a cold pulverizer 14 are used to decontaminate the scrap plastic feed. In Step 2, a twin screw extruder 20 and breaker plate with revolving screen 22 are used to further process the product of Step 1, with a portion of the further processed product recycled to the pulverizer 14. In Step 3, product from the breaker plate with revolving screen 22 is assessed in an assessment station 30, where virgin plastic can be added, if necessary, to achieve an acceptable fiber for strand for coating. The resulting un-surfaced warm fiber strand 32 has a diameter of 0.80 to 1.20 mm. The un-surfaced warm fiber strand 32 is pre-surfaced at a pressure of 2000 psi to yield a pre-surfaced strand 36. A mixture of 20% by weight M-DCPD to 80% by weight precipitated silica is combined with dimethylformamide and tetrahydrofuran to yield Solution #1, which contains 10% by weight dimethylformamide and 70% by weight tetrahydrofuran, with the remainder comprising the mixture of M-DCPD and precipitated silica. A roller 38 is employed to embed the precipitated silica of Solution #1 into the pre-surfaced strand 36, which is subjected to a flash cure 39 of deposited Solution #1. Solution #2 is then applied in a fogging chamber 40 to the pre-surfaced strand 36 and subjected to a flash cure 42. Solution #2 comprises 15% by weight nano-montmorillonite, 20% by weight tetrahydrofuran, and 65% water. The resulting fiber is then subjected to clipping and packaging 44 to yield a pozzolanic fiber (P47) suitable for use in reinforcing cement. The finished strand 46 (depicted in cross-section in FIG. 3), having a diameter of approximately 1 mm, has a surface coating of embedded precipitated silica (approx. 10 micron thickness) with intercalated nano-montmorillonite (approx. 5-10 micron thickness).

As an optional step, an amino-silane binary coupling agent can be deposited on the fiber to enhance nano-montmorillonite (or bentonite) binding to the plastic component of the fiber and/or to reinforce binding of any plastic surface to cement inorganic structures. An example of an amino-silane (or N-silyl amine) is 3-Triethoxysilylpropylamine, having a structure NH₂(CH₂)₃Si(OC₂H₅)₃ (CAS 919-30-2). The amino-silane is typically deposited in an amount of 1.0-1.5% by weight with respect to the plastic component weight. Other amino-silanes may also be suitable for use, e.g., 3-trimethoxysilylpropylamine, 3-tripropoxysilylpropylamine, 3-trimethoxysilylethylamine, 3-trimethoxysilylmethylamine, etc. The amino-silane can be added at any stage in the process (e.g., as a last step of the process), separately or in combination with addition of Solution #1 or Solution #2, or before or after addition of Solution #1 or Solution #2. It can be added in pure form or in admixture with a solvent or other carrier.

### Cellulosic Nano-Fiber

A robust and feasible strategy is provided to process cellulose nano fibers (CNFs) into a high performance bulk structural material with low density, outstanding strength and toughness, and great thermal dimensional stability. It offers a green paradigm shift for the reinforcement of large scale materials such as portland concrete, plastic articles such as car parts and articles for use in a marine environment, as well as impact elastomers.

Cellulose nanomaterials are conventionally produced by various methodologies, including electrospinning, bacterial generation, acid digestion, and a variety of mechanical defibrillation techniques. The morphology of the nanomaterial produced is specific to the production process. Feedstocks range from various forms of woody biomass to fungi. The type of feedstock can impact properties of the resulting product. A mechanical defibrillation technique is advantageously employed to continuously break down cellulose fibers suspended in water via segmentation and defibrillation through grinding and refining. The process is typically operated until a desired level of fines is achieved in the resultant slurry of cellulose nanofiber (CNF, alternatively referred to as “cellulose nanofibril”). Mechanical defibrillation processes can be built to produce several liters in a small batch system, and up to tons per day in a continuous pilot scale refinery system.

Following initial dehydration, the untreated CNF is processed by consecutive spray-roller-squeezing application of poly vinyl alcohol (PVA), followed by silicic acid solution. Other chemical coatings may be employed with this application method, such as tetramethylpiperidinyl-oxyl (TEMPO). Depending upon the composite structure within which the CNF compounded is to be utilized, such as polypropylene and/or inorganic materials such as calcium bentonite, the coating can be adjusted to achieve desired final specifications.

The Coated CNF is then dried/crosslinked in a continuous oven. The resulting product is useful in preparing various composite materials.

Where CNFs are the basic building blocks of a material, hydrogen bonds are the main interaction that bind them together. The strength (at least 2 GPa) and Young's modulus (about 138 GPa) of individual CNFs can be almost as high as those of steel and Kevlar, and those superior nanoscale properties can be scaled to the macro level, mainly due to the strong interaction between CNFs and the matrix within which the fiber is utilized, such as portland cement, concrete, plastic, or rubber.

An outstanding performance standard for lightweight biopolymers is exhibited by dragline silk. CNFs prepared as described herein can outperform dragline silk 8× in terms of stiffness, and with similar strengths. Properly compounded, CNFs may exceed the physical strengths of metals, alloys and silica-based E-glass fibers.

In certain embodiments, the CNFs can be reacted to form a ferro material. This process starts by modifying soybean oil (SBO) in a first reactor via a ring opening metathesis using a Diels-Alder reaction between the SBO and tetracycanoethylene yielding a norbornene ligand. Then, within a second reactor a second stage reaction is conducted by grafting one or more of the numerous species of crystallized nano-cellulose to the norbornene ring. In a third reactor, the two reactor polymers are titrated for optimal results. An iron species, e.g., iron oxide nanoparticle or nano iron sulfide superconductor, is then added into the resulting polymer mix to yield a ferro-cellularized soybean oil (FC—SBO, available from Natural Composites, LLC, Bullhead City, AZ).

The FC—SBO exhibits sulfur scavenging activity in vulcanized materials, and can be employed in reaction with ground tire rubber (GTR). A material compounded from ferro-cellularized soybean oil (FC—SBO, available from Natural Composites, LLC, Bullhead City, AZ) and ground tire rubber (in a 5:95 mass ratio, or higher or lower, e.g., 1:99 or 2:98, or any value or range in between) is provided offering advantageous properties. The FC—SBO adds considerable hydrogen sites to the permutated GTR, resulting in a significant gain in the recompounded tensile and elongation properties of the permutated GTR. The FC—SBO can also be employed as an additive in plastics, e.g., recycled plastics, to provide improved properties.

In applications such as portland cement, the FC—SBO is not employed as a sulfur scavenger, and can be used at lower levels, e.g., a mass ratio of FC—SBO to portland cement of 2:98 (or higher or lower, e.g., 0.5:99.5, or 1:99, or any range or value in between). The FC—SBO imparts repelling forces to the fibers in the portland cement, thereby reducing clumping and enabling fiber (e.g., of cellulose nanofiber) loading to increase from the 1% by weight for fibers conventionally employed to as much as a 10% by weigh loading levels or more (e.g., 2 to 10% by weight, optionally 5 to 10% by weight).

### Pozzolanic Materials in Cements

Any suitable pozzolanic material can be employed in providing the outer coating of the fiber. The general definition of a pozzolan embraces a large number of materials which vary widely in terms of origin, composition and properties. Both natural and artificial (man-made) materials show pozzolanic activity and are used as supplementary cementitious materials. Artificial pozzolans can be produced deliberately, for instance by thermal activation of kaolin-clays to obtain metakaolin, or can be obtained as waste or by-products from high-temperature process such as fly ashes from coal-fired electricity production. The most commonly used pozzolans today are industrial by-products such as fly ash, silica fume from silicon smelting, highly reactive metakaolin, and burned organic matter residues rich in silica such as rice husk ash. Natural pozzolanic materials include volcanic ash and pumices largely composed of volcanic glass and diatomaceous earths. Natural as well as synthetic zeolites can also be pozzolanic materials.

The properties of hardened blended cements are strongly related to the development of the binder microstructure (e.g., to the distribution, type, shape and dimensions of both reaction products and pores). The beneficial effects of pozzolan addition in terms of higher compressive strength, performance and greater durability are mostly attributed to the pozzolanic reaction in which calcium hydroxide is consumed to produce additional C—S—H and C-A-H reaction products. These pozzolanic reaction products fill in pores and result in a refining of the pore size distribution or pore structure. This results in a lowered permeability of the binder. The contribution of the pozzolanic reaction to cement strength is usually developed at later curing stages, depending on the pozzolanic activity. The increased chemical resistance to the ingress and harmful action of aggressive solutions constitutes one of the main advantages of pozzolan blended cements. The improved durability of the pozzolan-blended binders lengthens the service life of structures and reduces the costly and inconvenient need to replace damaged construction.

One of the principal reasons for increased durability is the lowered calcium hydroxide content available to take part in deleterious expansive reactions induced by, for example, sulfate attack. Furthermore, the reduced binder permeability slows down the ingress of harmful ions such as chlorine or carbonate. The pozzolanic reaction can also reduce the risk of expansive alkali-silica reactions between the cement and aggregates by changing the binder pore solution. Lowering the solution alkalinity and increasing alumina concentrations strongly decreases or inhibits the dissolution of the aggregate aluminosilicates.

The pozzolanic fibers are typically added to portland cement, however, they can also be added separately to a concrete mixture prior to hardening, or to cements other than portland cement. Portland cement is made up of four main compounds: tricalcium silicate (3CaO·SiO₂), dicalcium silicate (2CaO·SiO₂), tricalcium aluminate (3CaO·Al₂O₃), and a tetra-calcium aluminoferrite (4CaO·Al₂O₃Fe₂O₃). In an abbreviated notation differing from the normal atomic symbols, these compounds are designated as C₃S, C₂S, C₃A, and C₄AF, where C stands for calcium oxide (lime), S for silica, A for alumina, and F for iron oxide. Small amounts of uncombined lime and magnesia also are present, along with alkalis and minor amounts of other elements. Upon mixing with water, the calcium silicates react with water molecules to form calcium silicate hydrate (3CaO·2SiO₂·3H₂O) and calcium hydroxide (Ca[OH]₂). These compounds are given the shorthand notations C—S—H (represented by the average formula C₃S₂H₃) and CH, and the hydration reaction can be crudely represented by the following reactions: 2C₃S+6H=C₃S₂H₃+3CH₂C₂S+4H=C₃S₂H₃+CH. During the initial stage of hydration, the parent compounds dissolve, and the dissolution of their chemical bonds generates a significant amount of heat. Then, for reasons that are not fully understood, hydration comes to a stop. This quiescent, or dormant, period is important in the placement of concrete.

Following the dormant period (which can last several hours), the cement begins to harden, as CH and C—S—H are produced. This is the cementitious material that binds cement and concrete together. As hydration proceeds, water and cement are continuously consumed. The C—S—H and CH products occupy almost the same volume as the original cement and water such that volume is approximately conserved and shrinkage is minimal. C—S-His an amorphous gel with a highly variable stoichiometry. The ratio of C to S, for example, can range from 1:1 to 2:1, depending on mix design and curing conditions.

The strength developed by portland cement depends on its composition and the fineness to which it is ground. The C₃S is mainly responsible for the strength developed in the first week of hardening and the C₂S for the subsequent increase in strength. The alumina and iron compounds that are present only in lesser amounts make little direct contribution to strength.

Set cement and concrete can suffer deterioration from attack by some natural or artificial chemical agents. The alumina compound is the most vulnerable to chemical attack in soils containing sulfate salts or in seawater, while the iron compound and the two calcium silicates are more resistant. Calcium hydroxide released during the hydration of the calcium silicates is also vulnerable to attack. Because cement liberates heat when it hydrates, concrete placed in large masses can cause the temperature inside the mass to rise as much as 40 °C (70 °F) above the outside temperature. Subsequent cooling can be a cause of cracking. The highest heat of hydration is shown by C₃A, followed in descending order by C₃S, C₄AF, and C₂S.

Five types of portland cement are standardized in the United States by the American Society for Testing and Materials (ASTM): ordinary (Type I), modified (Type II), high-early-strength (Type III), low-heat (Type IV), and sulfate-resistant (Type V). In other countries Type II is omitted, and Type III is called rapid-hardening. Type V is known in some European countries as Ferrari cement.

There also are various other special types of portland cement. Colored cements are made by grinding 5 to 10 percent of suitable pigments with white or ordinary gray portland cement. Air-entraining cements are made by the addition on grinding of a small amount, about 0.05 percent, of an organic agent that causes the entrainment of very fine air bubbles in a concrete. This increases the resistance of the concrete to freeze-thaw damage in cold climates. The air-entraining agent can alternatively be added as a separate ingredient to the mix when making the concrete. Low-alkali cements are portland cements with a total content of alkalis not above 0.6 percent. These are used in concrete made with certain types of aggregates that contain a form of silica that reacts with alkalis to cause an expansion that can disrupt a concrete. Masonry cements are used primarily for mortar. They consist of a mixture of portland cement and ground limestone or other filler together with an air-entraining agent or a water-repellent additive. Waterproof cement is the name given to a portland cement to which a water-repellent agent has been added. Hydrophobic cement is obtained by grinding portland cement clinker with a film-forming substance such as oleic acid in order to reduce the rate of deterioration when the cement is stored under unfavorable conditions. Oil-well cements are used for cementing work in the drilling of oil wells where they are subject to high temperatures and pressures, and typically consist of portland or pozzolanic cement with organic retarders to prevent the cement from setting too quickly.

The granulated slag made by the rapid chilling of suitable molten slags from blast furnaces forms the basis of another group of constructional cements. Certain mixtures of portland cement and granulated slag contain up to 40-85% slag, e.g., 65 percent slag. Properties of these slag cements are broadly similar to those of portland cement, but they have a lower lime content and a higher silica and alumina content. Those with the higher slag content have an increased resistance to chemical attack. Another type of slag-containing cement is a supersulfated cement consisting of granulated slag mixed with 10 to 15 percent hard-burned gypsum or anhydrite (natural anhydrous calcium sulfate) and a few percent of portland cement. The strength properties of supersulfated cement are similar to those of portland cement, but it has an increased resistance to many forms of chemical attack.

High-alumina cement is a rapid-hardening cement made by fusing at 1,500 to 1,600 °C (2,730 to 2,910 °F) a mixture of bauxite and limestone in a reverberatory or electric furnace or in a rotary kiln. It also can be made by sintering at about 1,250 °C (2,280 °F). Suitable bauxites contain 50 to 60 percent alumina, up to 25 percent iron oxide, not more than 5 percent silica, and 10 to 30 percent water of hydration. The limestone must contain only small amounts of silica and magnesia. The cement contains 35 to 40 percent lime, 40 to 50 percent alumina, up to 15 percent iron oxides, and preferably not more than about 6 percent silica. The principal cementing compound is calcium aluminate (CaO·Al₂O₃). High-alumina cement gains a high proportion of its ultimate strength within 24 hours and has a high resistance to chemical attack. It also can be used in refractory linings for furnaces. A white form of the cement, containing minimal proportions of iron oxide and silica, has outstanding refractory properties.

Expanding and nonshrinking cements expand slightly on hydration, thus offsetting the small contraction that occurs when fresh concrete dries for the first time. One type is a mixture of portland cement and an expansive agent made by clinkering a mix of chalk, bauxite, and gypsum.

Gypsum plasters are used for plastering, the manufacture of plaster boards and slabs, and in one form of floor-surfacing material. These gypsum cements are mainly produced by heating natural gypsum (calcium sulfate dihydrate, CaSO₄·2H₂O) and dehydrating it to give calcium sulfate hemihydrate (CaSO₄·½H₂O) or anhydrous (water-free) calcium sulfate. Gypsum and anhydrite obtained as by-products in chemical manufacture also are used as raw materials.

The hemihydrate, known as plaster of Paris, sets within a few minutes on mixing with water; for building purposes a retarding agent, normally keratin, a protein, is added. The anhydrous calcium sulfate plasters are slower-setting, and often another sulfate salt is added in small amounts as an accelerator.

Various tests to which cements must conform are laid down in national cement specifications to control the fineness, soundness, setting time, and strength of the cement. Fineness was long controlled by sieve tests, but more sophisticated methods are now largely used. The most common method, used both for control of the grinding process and for testing the finished cement, measures the surface area per unit weight of the cement by a determination of the rate of passage of air through a bed of the cement. Other methods depend on measuring the particle size distribution by the rate of sedimentation of the cement in kerosene or by elutriation (separation) in an airstream. After it has set, a cement must not undergo any appreciable expansion, which could disrupt a mortar or concrete. This property of soundness is tested by subjecting the set cement to boiling in water or to high-pressure steam. Unsoundness can arise from the presence in the cement of too much free magnesia or hard-burned free lime. The setting and hardening of a cement is a continuous process, but two points are distinguished for test purposes. The initial setting time is the interval between the mixing of the cement with water and the time when the mix has lost plasticity, stiffening to a certain degree. It marks roughly the end of the period when the wet mix can be molded into shape. The final setting time is the point at which the set cement has acquired a sufficient firmness to resist a certain defined pressure. Most specifications require an initial minimum setting time at ordinary temperatures of about 45 minutes and a final setting time no more than 10 to 12 hours. The tests that measure the rate at which a cement develops strength are usually made on a mortar commonly composed of one part cement to three parts sand, by weight, mixed with a defined quantity of water. Tensile tests on briquettes, shaped like a figure eight thickened at the center, were formerly used but have been replaced or supplemented by compressive tests on cubical specimens or transverse tests on prisms. The American Society for Testing and Materials (ASTM) specification requires tensile tests on a 1:3 cement-sand mortar and compressive tests on a 1:2.75 mortar. The British Standards Institution (BSI) gives as alternatives a compressive test on a 1:3 mortar or on a concrete specimen. An international method issued by the International Organization for Standardization (ISO) requires a transverse test on a 1:3 cement-sand mortar prism, followed by a compressive test on the two halves of the prism that remain after it has been broken in bending. Many European countries have adopted this method. In all these tests the size grading of the sand, and usually its source, is specified. In the testing of most cements, a minimum strength at 3 and 7 days and sometimes 28 days is specified, but for rapid-hardening portland cement a test at 1 day also is sometimes required. For high-alumina cement, tests are required at 1 and 3 days. Strength requirements laid down in different countries are not directly comparable because of the differences in test methods. In actual construction, to check the strength of a concrete, compressive tests are made on cylinders or cubes made from the concrete being placed.

Use of pozzolanic materials in portland cement may offer one or more advantages, including replacing a substantial part of the portland cement by cheaper natural pozzolans or industrial by-products; lowering of the blended cement environmental cost associated with the greenhouse gases emitted during portland cement production, and increased durability of the end product. A reduction of 40 percent or more of portland cement in a concrete mix may be feasible when replaced with a combination of pozzolanic materials. Pozzolanic materials can be used to control setting, increase durability, reduce cost and reduce pollution without significantly reducing the final compressive strength or other performance characteristics of the resulting concrete mix. The fiber component of the pozzolanic fiber adds structural strength to the resulting hardened mass. High loadings, e.g., loadings of up to 10 wt. % or more, e.g., 2-10 wt. %, or e.g., 2, 3, 4, 5, 6, 7, 8, 9, or 10 wt. % or more, of the pozzolanic fiber in portland concrete can be achieved.

### Example 1

Pozzolanic fibers were prepared by the following procedure. In a first step, a recycled plastic material (mixed plastics from a recycling center in San Bernadino, CA) was subjected to decontamination via a wash plant, metal separator, and a cold pulverizer. The resulting material was passed through a twin screw extruder then a breaker plate with a revolving screw. The resulting material was then passed through a second extruder. In a third step, the material from the extruder was passed to a polymer assessment station for compositional analysis to determine if addition of virgin plastic was necessary. This yielded an un-surfaced warm fiber strand, having a diameter of approximately 0.80-1.20 mm. This strand was pre-surfaced by being subjected to pressure (e.g. 2000 psi). The strand was then coated with a solution of precipitated silica and the strand passed through a roller to embed the precipitated silica. The solution contained maleic anhydride-dicyclopentadiene resin (M-DCPD) and precipitated silica at a ratio of 20:80 at 20%, tetrahydrofuran (THF) at 70%, and dimethylformamide at 10%. The precipitated silica solution was flash cured to the strand. In a fourth step, a solution containing the pozzolanic material was coated on the strand and subject to two flash curing steps. The pozzolanic material was provided as a solution of nano-montmorillonite (15%), tetrahydrofuran (20%) and water (65%). The resulting strand (P47 fiber) was clipped and packaged for use.

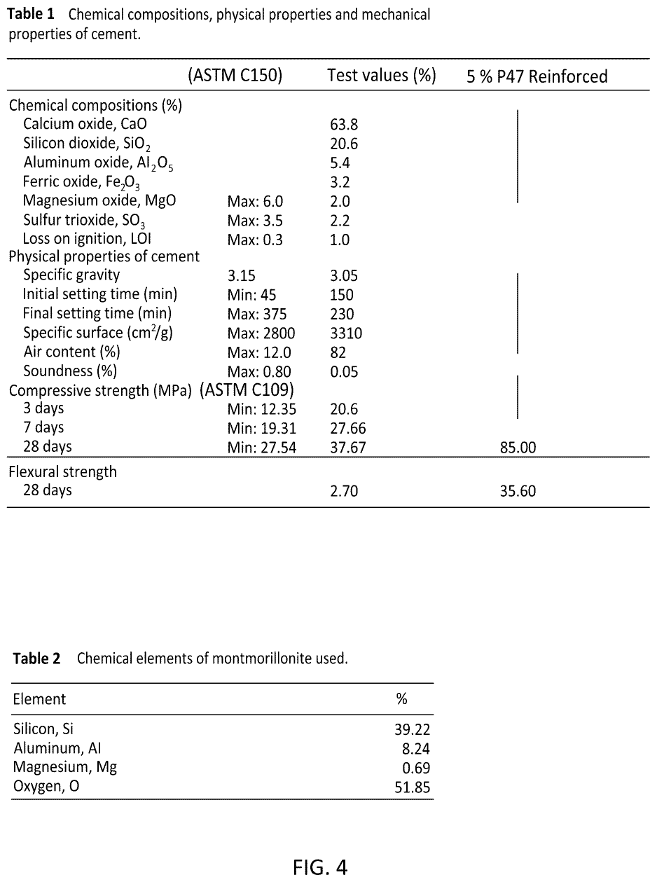

A cement was prepared having a composition as described in FIG. 4/Table 1, reinforced with 5 wt. % P47 fiber, as described above and as prepared as depicted in FIG. 3. Properties for the unreinforced cement, determined by ASTM C150-07 “Standard Specification for Portland Cement” are provided in FIG. 4/Table 1. Compressive strength (ASTM C109/C109M-20 “Standard Test Method for Compressive Strength of Hydraulic Cement Mortars (Using 2-in. or [50-mm] Cube Specimens) for the cement reinforced with 5% P47 fiber at 28 days was measured at 89.00, significantly higher than that observed for unreinforced cement. Flexural strength at 28 days was measured at 38.60 for the P47 fiber reinforced cement, significantly higher than the 2.70 observed for unreinforced cement. Bench tests on the samples showed increases to both flexural and compression values from P47 reinforcement substantially superior to any published values for similarly compounded portland cement, at notable reductions in the weight/unit of volume of such referenced concrete compounds.

### Example 2

### Materials, Mixture Proportions and Preparation of Specimens

The High Performance Concrete Coating (HPCC) matrix used for preparing samples had an average compressive strength of 82 MPa, splitting tensile strength of 5 MPa, and fracture energy of 0.1 N/mm. The impact of fibers on the HPCC properties was studied on cementitious composite with a water-to-binder materials ratio (w/csf) of 0.3. Table 2 below shows the mixture proportions of all the HPCC components. Portland type I cement-CEM I 52.5R (CEMEX, Chełm, Poland) (specific surface area of 484 m²/kg), dense silica fume (STANCHEM, Niemce, Poland) (specific surface area of 17,000 m²/kg), sand with a grain size of 0.125/1 mm (specific weight of 1710 kg/m³ and absorption coefficient of 1.9%), polycarboxylate ethers-based superplasticizer (CEMEX Admixtures GmbH, Salzkotten, Germany) (specific weight of 1070 kg/m³), and tap water were used in all mixtures. Fine aggregate in saturated surface-dry condition was utilized. The dosage of superplasticizer was adjusted to provide a target flow of 850±10 mm for HPCC-S3%, corresponding to a slump III flow (SF₃) class.

TABLE 2

| | HPCC- | HPCC- | HPCC- | HPCC- |
|---|---|---|---|---|
| Component | S3% | PP3% | FXCC3% | G3% |
| Cement (kg/m³) | 947 | 947 | 947 | 947 |
| Silica fume | 54 | 54 | — | 54 |
| (kg/m³) | | | | |
| Sand (kg/m³) | 1042 | 1042 | 1042 | 1042 |
| Plasticizer | — | — | — | — |
| (L/m³) | | | | |
| Water (L/m³) | 312 | 312 | 285 | 312 |
| Steel fiber | 234 | | | |
| (kg/m³) | | | | |
| PP fiber | — | 27 | — | — |
| (kg/m³) | | | | |
| FXCC fiber | — | — | 70 | — |
| (kg/m³) | | | | |
| Glass fiber | — | — | 75 | — |
| (kg/m³) | | | | |

Note:
HPCC-A3% refers to a high performance cementitious composite where “A” is the type of fiber, i.e., S is steel fiber, PP is polypropylene fiber, FXCC is composite fiber, and G is glass fiber; each at a 3% constant fiber volume content.

### Fiber Specification(s)

The four fiber types were added to the base HPCC: long steel fibers with a hooked-end shape (length of 50 mm), crimped macro-synthetic polypropylene fibers (40 mm long), medium chopped FXCC fibers (30 mm long), and short chopped glass fibers (18 mm long). Fiber properties are provided in Table 3 and testing results for fiber reinforced HPCC samples as described in Table 1 are provided in Table 4.

TABLE 3

| Fiber Property | S | PP | FXCC | G |
|---|---|---|---|---|
| Diameter (mm) | 1.0 | 0.75 | 0.85 | 0.014 |
| Density | 7800 | 910 | 2200 | 2500 |
| (kg/M3) | | | | |
| Elastic Modulus | 200 | 3.6 | 105 | 72 |
| (GPa) | | | | |
| Tensile Strength | >1060 | >360 | >1500 | >1700 |
| (MPa) | | | | |

TABLE 4

| Tests | Steel | Polypropylene | Composite | Glass |
|---|---|---|---|---|
| Performed | (S) | (PP) | Fiber (FXCC) | (G) |
| Comp. Strength | 103 | 94 | 98 | 83 |
| (MPa) | | | | |
| Splitting Ten. | 16 | 7 | 15 | 12 |
| Strength (MPa) | | | | |
| Flexural | 8 | 4 | 15 | 13 |
| Strength | | | | |

### SUMMARY

The montmorillonite/bentonite, embedded cladding of the FXCC composite fiber provides multiple advantages:
1) Chemical bonding to the portland concrete matrix, thereby providing superior stress/strain transfer of the live loads placed on the concrete substrate.
2) A low coefficient of friction to the stick-like fiber structures, otherwise slump flow of the self-compacting concrete.
3) Superior strength by eliminating chemical plasticizers and excess water.
4) Significantly lower costs by additive elimination and bulk density: cost ratio with equal or better performance as compared to the most popular fibers used in high performance concrete i.e., steel and glass fibers.
5) Sustainability by using waste raw materials.
6) Thinner concrete cross-sections with equal or better performance in regular grades of concrete at lower fiber loadings.
7) Substantially reduced industry carbon footprint due to better performance even at thinner concrete cross-sections.

While the disclosure has been illustrated and described in detail in any drawings and the foregoing description, such illustration and description are to be considered illustrative or exemplary and not restrictive. The disclosure is not limited to the disclosed embodiments. Variations to the disclosed embodiments can be understood and effected by those skilled in the art in practicing the claimed disclosure, from a study of the drawings, the disclosure and the appended claims.

All references cited herein are incorporated herein by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments. Any ratio is a weight ratio unless otherwise specified. Any percentage is by weight unless otherwise specified.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

1. A pozzolanic fiber, comprising a polymeric fiber having a coating comprising a precipitated silica and a maleic anhydride-dicyclopentadiene resin interlocked with a montmorillonite.

2. The pozzolanic fiber of claim 1, wherein the polymeric fiber comprises one or more polymers selected from the group consisting of polyethylene terephthalate, high density polyethylene, polyvinyl chloride, low density polyethylene, polypropylene, and polystyrene.

3. The pozzolanic fiber of claim 2, wherein the one or more polymers is derived from a recycled material.

4. The pozzolanic fiber of claim 2, wherein the one or more polymers is virgin polymer.

5. The pozzolanic fiber of claim 1, wherein the polymeric fiber has a diameter of 0.5 to 2 mm, optionally 1.0 to 1.5 mm, optionally 1.2 mm.

6. The pozzolanic fiber of claim 1, wherein the polymeric fiber has an aspect ratio of from 5:1 to 100:1, optionally 10:1 to 50:1, optionally 10:1, optionally 20:1, optionally 30:1, optionally 40:1, optionally 50:1, optionally 60:1, optionally 70:1, optionally 80:1, optionally 90:1, or optionally 100:1.

7. The pozzolanic fiber of claim 1, wherein the precipitated silica has a cured coating thickness of 7-10 nm and is reaction coated with an approximately 10-30 nanometers, optionally 20 nanometer thick surfacing of maleic anhydride-dicyclopentadiene resin.

8. The pozzolanic fiber of claim 1, wherein the precipitated silica of the coating comprises a plurality of shafts, each with an individual shaft diameter of approximately 150-300 nm with an aspect ratio of approximately 10-30:1, optionally 20:1.

9. The pozzolanic fiber of claim 1, wherein the montmorillonite is a nano-montmorillonite.

10. The pozzolanic fiber of claim 1, wherein the montmorillonite is a Na-montmorillonite, a Li-montmorillonite, or a Ca-montmorillonite.

11. The pozzolanic fiber of claim 1, wherein the montmorillonite is a bentonite.

12. The pozzolanic fiber of claim 1, wherein the coating further comprises an amino-silane, optionally 3-trimethoxysilylpropylamine.

13. A cementitious material, optionally a portland cement, comprising a pozzolanic fiber of claim 1, wherein the pozzolanic fiber is optionally present at 1-10 wt. %, optionally 5 wt. %.

14. A concrete, comprising a cementitious material, optionally portland cement, and a pozzolanic fiber of claim 1.

15. A method of preparing a pozzolanic fiber, comprising:
coating a polymeric fiber with a solution of a precipitated silica and a maleic anhydride-dicyclopentadiene resin and flash curing to remove any volatiles, whereby a cured coating is obtained; and
depositing a solution of montmorillonite onto the cured coating and flash curing to remove any volatiles,
whereby a pozzolanic fiber is obtained.

16. A cellulose nanofiber, wherein the cellulose nanofiber is treated with polyvinyl alcohol followed by silicic acid, optionally with tetramethylpiperidinyl-oxyl.

17. A rubber material comprising a ground tire rubber and a ferro-cellularized soybean oil.

18. The rubber material of claim 17, wherein a ratio of ferro-cellularized soybean oil to ground tire rubber is 5:95 by weight.

19. A cementitious material comprising a cement, optionally portland cement, and a ferro-cellularized soybean oil.

20. The cementitious material of claim 19, further comprising cellulose nanofibers, wherein the cellulose nanofibers comprise from 2 to 10% by weight of the cementitious material.
